(19) United States
(12) Patent Application Publication
(10) Pub. No.: US 2021/0088130 A1
(43) Pub. Date: Mar. 25, 2021

(54) HYDRAULIC SYSTEM WITH PUMP OUTPUT SWITCHED BY LUBRICATION COMMAND AND TRANSMISSION INCLUDING THE SAME

(71) Applicant: BorgWarner Inc., Auburn Hills, MI (US)

(72) Inventors: Keith V. FELDT, Ithaca, NY (US); Chengyun GUO, Novi, MI (US); Christopher E. BLAIR, Fenton, MI (US)

(21) Appl. No.: 16/954,277

(22) PCT Filed: Dec. 20, 2017
(86) PCT No.: PCT/US2017/067623

§ 371 Date: Jun. 16, 2020

(51) Int. Cl. F16H 61/00; F16H 61/02

(52) U.S. Cl. CPC F16H 61/0031; F16H 61/0206; F16H 2061/0253; F16H 2061/0037; F16H 61/0251

(57) ABSTRACT

A hydraulic circuit for moving a fluid includes an electric pump, a primary circuit, and a secondary circuit. The hydraulic circuit also includes a controller and a hydraulic control module. The hydraulic control module includes a solenoid valve assembly. Moreover, the controller is configured to control a pressure of the fluid at the output of the solenoid valve assembly. Finally, the hydraulic control module includes a switch valve assembly configured to selectively route the fluid from the pump to the primary circuit when the pressure of the fluid at the output of the solenoid valve assembly is lower than a predetermined pressure and to selectively route the fluid to the secondary circuit when the pressure of the fluid at the output of the solenoid valve assembly is greater than the predetermined pressure.

### BACKGROUND OF THE INVENTION

### 1. Field of the Invention

The subject invention generally relates to a hydraulic circuit which includes a switch valve assembly for controlling a fluid and a control method for controlling the switch valve assembly.

### 2. Description of the Related Art

Conventional vehicles include a transmission operably coupled with a hydraulic circuit. The hydraulic circuit may include a pump which is configured to provide pressurized fluid flow throughout the hydraulic circuit and the transmission. The transmission may also be operably coupled to a clutch system. In some applications, it is advantageous to direct output of the pump to either a high-pressure circuit or a low-pressure lubrication circuit which provides lubrication to the clutch system.

Conventional vehicles may direct the output of the pump using a switching valve which is controlled by main line pressure. However, using line pressure as a signal for the switch valve may cause undesirable flow restriction through the switch valve under certain line pressure conditions. As such, there remains a need for a hydraulic circuit to direct the output of the pump using an alternative system and/or control method. Additionally, there remains a need for a hydraulic circuit which allows more direct control of the switch valve and includes, at a minimum, adequate openings of the switch valve during all operating conditions.

### SUMMARY OF THE INVENTION AND ADVANTAGES

A hydraulic system for moving a fluid includes an electric pump and a primary circuit fluidly coupled to the pump. The hydraulic system includes a controller and a hydraulic circuit. The hydraulic circuit includes a secondary circuit coupled with the pump. Additionally, the hydraulic circuit includes a hydraulic control module for controlling output of the fluid from the pump. The hydraulic control module includes a solenoid valve assembly. Moreover, the controller is configured to control a pressure of the fluid at the output of the solenoid valve assembly. The hydraulic control module also includes a switch valve assembly configured to selectively route the fluid from the pump to the primary circuit when the pressure of the fluid at the output of the solenoid valve assembly is lower than a predetermined pressure of the fluid at the output of the solenoid valve assembly and to selectively route the fluid to the secondary circuit when the pressure of the fluid at the output of the solenoid valve assembly is greater than the predetermined pressure of the fluid at the output of the solenoid valve assembly.

A transmission system for a vehicle includes a transmission; an electric pump coupled to the transmission; a mechanical pump coupled to the transmission; and a hydraulic circuit for moving a fluid which includes a pump and a primary circuit for fluidly coupled to the pump. The hydraulic circuit also includes a secondary circuit fluidly coupled with the pump. Additionally, the transmission includes a controller; and a hydraulic control module for controlling output of the fluid from the pump. The hydraulic control module includes a solenoid valve assembly. Moreover, the controller is configured to control a pressure of the fluid at the output of the solenoid valve assembly. Additionally, the hydraulic control module includes a switch valve assembly configured to selectively route the fluid from the pump to the primary circuit when the pressure of the fluid at the output of the solenoid valve assembly is lower than a predetermined pressure of the fluid at the output of the solenoid valve assembly and to selectively route the fluid to the secondary circuit when the pressure of the fluid at the output of the solenoid valve assembly is greater than the predetermined pressure of the fluid at the output of the solenoid valve assembly.

A method for controlling fluid flow within a hydraulic circuit includes the hydraulic circuit system having a controller and a hydraulic circuit coupled with the controller. The hydraulic circuit includes pump; a primary circuit coupled with the pump; a secondary circuit fluidly coupled with the pump; and a hydraulic control module for controlling output of the fluid from the pump, the hydraulic control module having a solenoid valve assembly. Additionally, the controller is configured to control a pressure of the fluid at the output of the solenoid valve assembly. The method includes routing the fluid from the electric pump to the primary circuit when the pressure of the fluid at the output of the solenoid valve assembly is lower than a predetermined pressure of the fluid at the output of the solenoid valve assembly and routing the fluid from the pump to the secondary circuit when the pressure of the fluid at the output of the solenoid valve assembly is greater than the predetermined pressure of the fluid at the output of the solenoid valve assembly.

The ability to utilize the signal pressure from a solenoid valve assembly to also control the switch valve assembly offers all of the benefits of using a designated control solenoid to control the switch valve assembly without the added expense or space requirements of an additional solenoid.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a vehicle having a powertrain system;

FIG. 2 is a schematic view of the hydraulic circuit;

FIG. 3 is a cross sectional view of an exemplary switch valve;

FIG. 4 is a schematic view of the hydraulic circuit assembly having the switch valve assembly directing fluid flow towards a primary circuit; and

FIG. 5 is a schematic view of the hydraulic circuit assembly having the switch valve assembly directing fluid flow towards a secondary circuit.

### DETAILED DESCRIPTION OF THE INVENTION

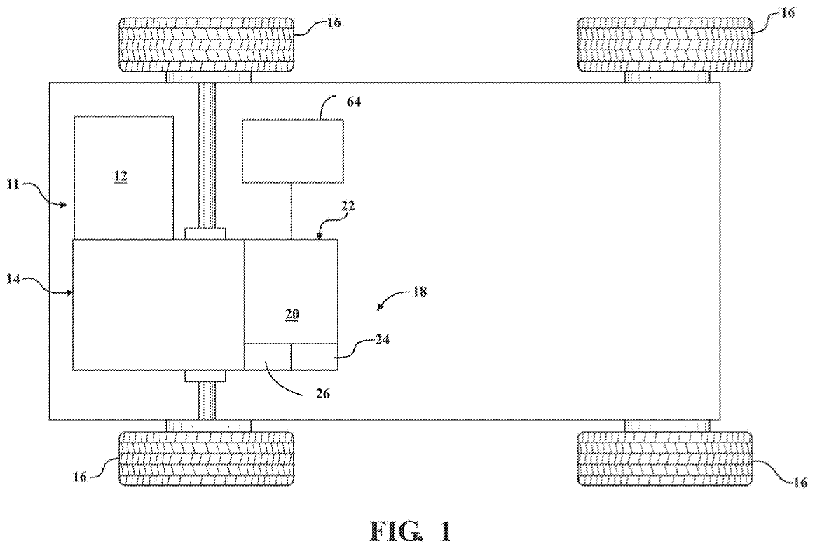

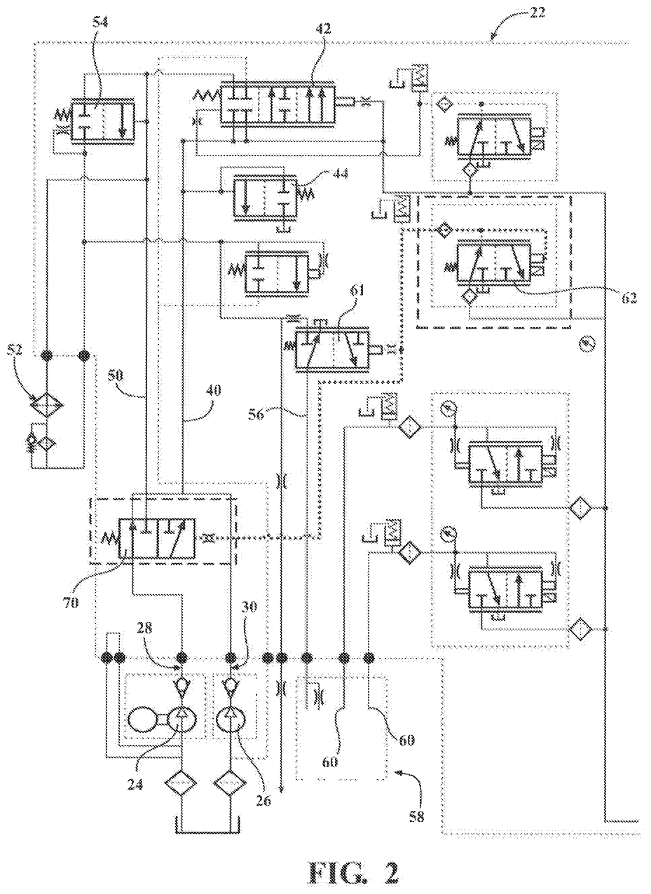

Referring now to the figures, where like numerals are used to designate like structure unless otherwise indicated, a vehicle is schematically illustrated at 10 in the figures. As illustrated in FIG. 1, the vehicle 10 includes a powertrain system 11 which includes an engine 12 in rotational communication with a transmission 14. The transmission 14 may be any type of transmission including an automatic or semi-automatic transmission as known by one of ordinary skill in the art. In one exemplary embodiment, the transmission 14 is an automatic dual clutch transmission; however, it is contemplated that the dual clutch transmission 14 may be any type of automatic or semi-automatic transmission. The engine 12 generates rotational torque which is selectively translated to the transmission 14 which, in turn, translates rotational torque to one or more wheels 16, generally indicated at 16. The transmission 14 is typically controlled using hydraulic fluid. To this end, the transmission 14 typically includes a hydraulic control module 20 that directs or otherwise controls fluid to the transmission 14. It should also be appreciated that the engine 12 and the transmission 14 of FIG. 1 are of the type employed in a conventional “transverse front wheel drive” powertrain system. It should further be appreciated that the engine 12 and/or transmission 14 could be configured in any suitable way sufficient to generate and translate rotational torque so as to drive the vehicle 10, without departing from the scope of the present invention. In the embodiment illustrated in FIG. 2, the pump 24 includes an inlet and at least one outlet 28. As described in more detail below, it is advantageous to be able to direct the output of the pump 24 to one or more locations.

Referring still to the embodiment illustrated in FIG. 1, a hydraulic system 21 is fluidly coupled to the transmission 14 and is configured for moving the hydraulic fluid. The hydraulic system 21 includes a hydraulic circuit 22. Moreover, the hydraulic circuit 22 includes at least one pump 24. In the embodiment illustrated in FIG. 1, the hydraulic circuit 22 is a dual pump system and includes the electrically driven pump 24 and a mechanically driven pump. In the embodiment illustrated in FIG. 1, the hydraulic circuit 22 is configured to direct the output of the electric pump 24. However, it is also contemplated that the hydraulic circuit 22 may be configured to direct the output of the mechanical pump 26 or to direct the output of both the electric pump 24 and the mechanical pump 26. It is contemplated that the pump 24 may include multiple outlets 28 each coupled to a separate circuit, or a single outlet 28 where the fluid is directed towards the desired location after flowing through the single outlet 28. It is contemplated that the mechanical pump 26 may be similar to the pump 24 described above in that the mechanical pump 26 may include an inlet and at least one outlet.

Referring now to the embodiment illustrated in FIG. 2, the hydraulic circuit 22 also includes a primary circuit 40. In the embodiment illustrated in FIG. 2, the primary circuit 40 fluidly couples the pump 24 to a pressure regulator 42 and is typically a high-pressure actuation circuit. However, it is also contemplated that the primary circuit 40 may be another type of circuit, as desired by one of ordinary skill in the art. As illustrated in FIG. 2, it is contemplated that the pressure regulator 42 may be the main pressure regulator 42 for the hydraulic circuit 22. Moreover, it is also contemplated that the primary circuit 40 may also include other elements including but not limited to a pressure relief valve 44.

Referring still to the embodiment illustrated in FIG. 2, the hydraulic circuit 22 also includes a secondary circuit 50. In the embodiment illustrated in FIG. 2, the secondary circuit 50 is a cooling circuit. However it is also contemplated that the secondary circuit may be any hydraulic circuit as known by one of ordinary skill in the art. In the embodiment where the secondary circuit 50 is a cooling circuit, the secondary circuit 50 fluidly couples a cooler 52 and the pump 24 and is typically a low pressure circuit. However, it is also contemplated that the secondary circuit 50 may be another type of circuit, as desired by one of ordinary skill in the art. The cooler 52 illustrated in the embodiment shown in FIG. 2 is a plate and fin cooler. However, it is contemplated that the cooler 52 may be any type of cooler typically disposed in the secondary circuit 50, including but not limited to a tube and fin cooler or a stacked plate cooler. It is also contemplated that the secondary circuit 50 may include other elements such as a cooler bypass valve 54 and/or another element as known by one of ordinary skill in the art.

Referring again to the embodiment illustrated in FIG. 2, the hydraulic circuit 22 further includes a clutch lubrication circuit 56. The clutch lubrication circuit 56 provides lubrication to a clutch assembly 58. The clutch assembly 58 is coupled to the vehicle transmission 14 and generally includes at least one clutch 60 and is typically controlled by a clutch solenoid. It is contemplated that the vehicle transmission 14 is a dual clutch transmission such that the transmission 14 includes two clutches 60 and two clutch solenoids. The clutch 60 may be any type of clutch as known by one of ordinary skill in the art including, but not limited to, a friction clutch such as a wet clutch, a multi-plate clutch, a dual clutch system, an electromagnetic clutch, or an electrohydraulic clutch without departing from the spirit of the invention. In the embodiment illustrated in FIG. 2, the clutch lubrication circuit 56 includes a main line having a plurality of branches coupled to a lube regulator valve 61 which is configured to allow lubrication into each of the clutches 60.

The clutch lubrication circuit 56 also includes a solenoid valve assembly 62. The solenoid valve assembly 62 is fluidly coupled with the clutch assembly 58, and more specifically, is configured to control fluid flow through the lube regulator valve 61. In the embodiment illustrated in FIG. 2, the solenoid valve assembly 62 is coupled to the main line by one of the plurality of branches. In one exemplary embodiment, the solenoid valve assembly 62 is a pressure proportional solenoid valve assembly 62. However, it is also contemplated that the solenoid valve assembly 62 may be any type of solenoid valve assembly 62 as known by one of ordinary skill in the art, including but not limited to a variable bleed solenoid or spool valve type pressure regulation solenoid. Moreover, it is also contemplated that the solenoid valve assembly 62 may be a 2-way, 3-way, or 4-way solenoid valve assembly 62, as desired by one of ordinary skill in the art.

As best illustrated in FIG. 1, the hydraulic system 21 also includes a controller 64. The controller 64 is coupled to the clutch lubrication circuit 56 and is configured to control a pressure of the fluid at the output of the solenoid valve assembly 62. It is contemplated that the controller 64 may be part of an electronic vehicle control system or may be a separate controller 64. It is also contemplated that the controller 64 may be capable of performing computations from known equations to determine the pressure of the fluid or other various operating conditions.

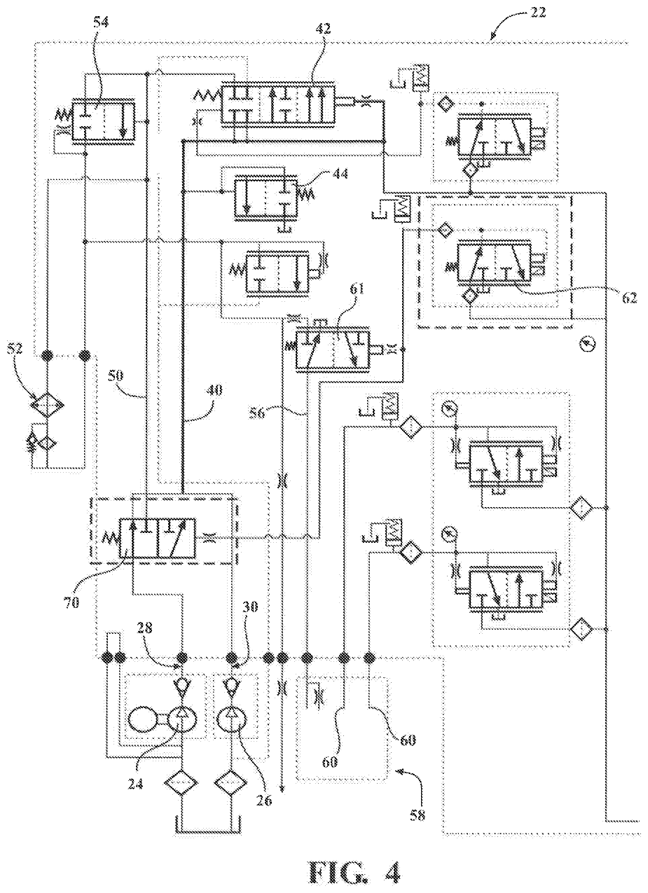

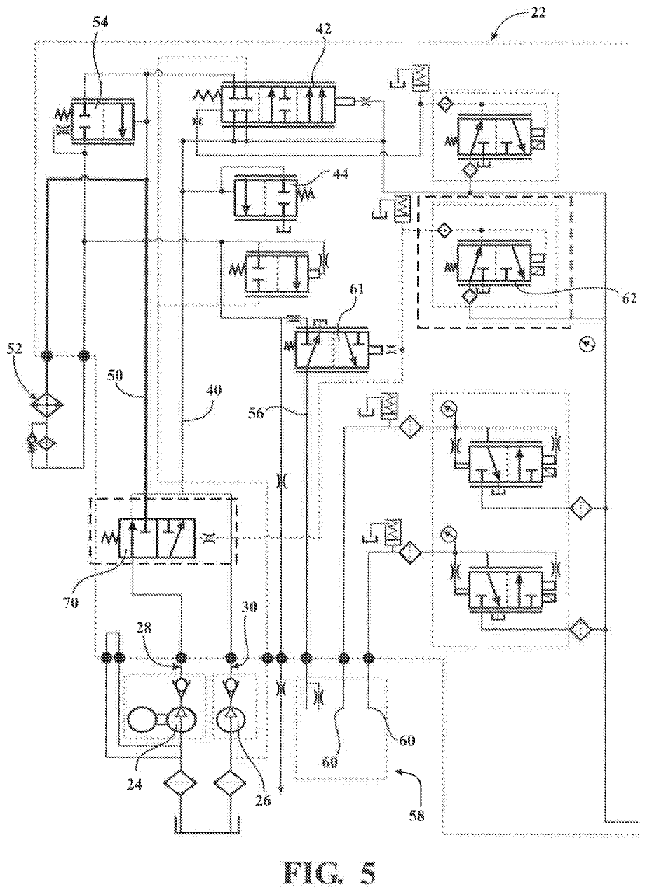

As additionally illustrated in FIG. 1, the hydraulic circuit 22 also includes the hydraulic control module 20. It is contemplated that the hydraulic control module 20 may be in communication with an electronic vehicle control system which includes the controller 64, as described above. Moreover, it is also contemplated that the controller 64 may be a mounted near the hydraulic control module 20 or may be a separate controller 64. The hydraulic control module 20 is configured to direct output of the fluid from the pump 24. More specifically, the hydraulic control module 20 is configured to control where the output of the fluid of the pump 24 is routed. In the embodiment illustrated in FIGS. 4-5, the hydraulic control module 20 is configured to selectively route the output of the fluid from the pump 24 to one or more of the primary circuit 40 or the secondary circuit 50 based on the pressure of the fluid at the output of the solenoid valve assembly 62 which is controlled by the controller 64.

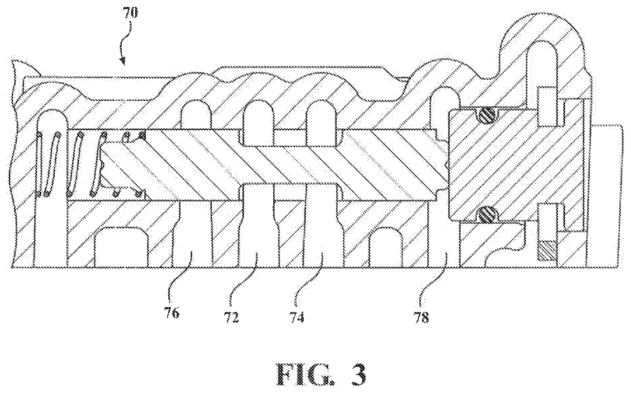

Referring now to the embodiment illustrated in FIG. 2, the hydraulic control module 20 also includes a switch valve assembly 70. It is contemplated that the switch valve assembly 70 may be any switch valve assembly 70 including but not limited to a two-way switch valve, a three-way switch valve, a four-way switch valve, and the like without departing from the spirit of the invention. An exemplary embodiment of the switch valve assembly 70 is illustrated in FIG. 3. In the embodiment illustrated in FIG. 3, the switch valve assembly 70 is a spring biased, two-way switch valve having an inlet 72 configured to receive the fluid from the pump 24, a first outlet 74, a second outlet 76, and a signal port 78. The first outlet 74 of the switch valve assembly 70 is coupled to the primary circuit 40 such that the switch valve assembly 70 is configured to direct fluid from the pump 24 to the primary circuit 40. The second outlet 76 of the switch valve assembly 70 is coupled to the secondary circuit 50 such that the switch valve assembly 70 is configured to direct fluid from the pump 24 to the secondary circuit 50. Additionally, the inlet 72 of the switch valve assembly 70 is coupled to the outlet 28 of the pump 24. Finally, the signal port 78 is fluidly coupled to the solenoid valve assembly 62 such that pressure of the fluid at the output of the solenoid valve assembly 62 acts on the signal port 78 to control the switch valve assembly 70.

In the embodiment illustrated in FIG. 2, the switch valve assembly 70 is configured to switch between directing the fluid from the pump 24 to the primary circuit 40 and from the pump 24 to the secondary circuit 50 based on the pressure of the fluid at the output of the solenoid valve assembly 62. It is contemplated that the pressure of the fluid at the output of the solenoid valve assembly 62 may be measured or calculated at an output of the solenoid valve assembly 62. However, it is also contemplated that the pressure of the fluid in the solenoid valve assembly 62 may be measured or calculated at an inlet of the solenoid valve assembly 62, or elsewhere inside the solenoid valve assembly 62, as desired by one of ordinary skill in the art.

The pressure of the fluid at the output of the solenoid valve assembly 62 may be constantly controlled by the controller 64. More specifically, the controller 64 continuously monitors operating conditions of the vehicle including but not limited to acceleration, brake rate, speed, images from vehicle cameras, etc. The controller 64 then uses that information to determine when it is desirable for the switch valve assembly 70 to route the fluid from the pump 24 to the primary circuit 40 or when it is desirable for the switch valve assembly 70 to route the fluid from the pump 24 to the secondary circuit 50. In order to control the switch valve assembly 70, the controller 64 uses known signal current to pressure of the fluid at the output of the solenoid valve assembly relationships. For example, if the controller 62 determines that it is desirable for the switch valve assembly 70 to route the fluid from the pump 24 to the primary circuit 40, the controller sends a signal of known current or PWM duty cycle which then commands a pressure of the fluid at the output of the solenoid valve assembly 62 which is below the predetermined pressure of the fluid at the output of the solenoid valve assembly 62. Therefore, the switch valve assembly 70 will route the fluid from the pump 24 to the primary circuit 40. If, on the other hand, the controller 64 determines that it is desirable for the switch valve assembly 70 to route the fluid from the pump 24 to the secondary circuit 50, the controller sends a signal of known current which then commands a pressure of the fluid at the output of the solenoid valve assembly 62 which is above the predetermined pressure of the fluid at the output of the solenoid valve assembly 62. Therefore, the switch valve assembly 70 will route the fluid from the pump 24 to the secondary circuit 50.

It is contemplated that the predetermined pressure of the fluid at the output of the solenoid valve assembly 62 may be a range of pressures, as desired by one of ordinary skill in the art., the switch valve assembly 70 is configured to route the fluid from the pump 24 to the primary circuit 40 when the pressure of the fluid at the output of the solenoid valve assembly 62 is less than a predetermined limit. Similarly, the switch valve assembly 70 is configured to route the fluid from the pump 24 to the secondary circuit 50 when the pressure of the fluid at the output of the solenoid valve assembly 62 is above a predetermined limit. It is contemplated that the predetermined limits may be the same value of different value in the predetermined range. In one exemplary embodiment, the predetermined pressure is set at approximately 6-6.6 bar such that switch valve assembly 70 is configured to route the fluid from the pump 24 to the primary circuit 40 when the pressure of the fluid at the output of the solenoid valve assembly 62 is less than 6 bar and the switch valve assembly 70 is configured to route the fluid from the pump 24 to the secondary circuit 50 when the pressure of the fluid at the output of the solenoid valve assembly 62 is greater than 6.6 bar. However, it is also contemplated that the predetermined pressure of the fluid at the output of the solenoid valve assembly 62 may be any pressure or range of pressures as desired by one of ordinary skill in the art.

The pressure of the fluid at the output of the solenoid valve assembly 62 is also used to control the lube regulator valve 61. However, the range of pressures of fluid at the output of the solenoid valve assembly used to control the lube regulator valve 61 is a separate range from the range of pressures of fluid at the output of the solenoid valve assembly used to control the switch valve assembly 70. In other words, the range of pressures of fluid at the output of the solenoid valve assembly used by the controller to control the direction of output of the fluid from the pump through the switch valve assembly 70 is a first range of pressures and the range of pressures of fluid at the output of the solenoid valve assembly used by the controller to control the lube regulator valve 61 is a second range of pressures. In at least one exemplary embodiment, the first range of pressures and the second range of pressures are separate ranges such that the first range of pressures and the second range of pressures do not overlap.

In operation, when the pump 24 is activated, fluid begins flowing from the output of the pump 24. Typically the pump 24 is activated upon vehicle 10 start-up, however the pump 24 may be activated prior to full vehicle 10 start-up or sometime after vehicle 10 start-up, as desired by one of ordinary skill in the art. The controller 64 is coupled to the solenoid valve assembly 62 and is configured to control the pressure of the fluid at the output of the solenoid valve 62. While the controller 64 determines that it is desirable for the fluid from the output of the pump 24 to be routed to the primary circuit 40, the controller 64 sends a signal of known current to the solenoid valve assembly 62 which produces a pressure of the fluid at the output of the solenoid valve assembly 62 that is below the predetermined pressure of the fluid at the output of the solenoid valve assembly 62. When the controller 64 instead determines that is desirable for the fluid from the output of the pump 24 to be routed to the secondary circuit 50, the controller 64 sends a signal of known current to the solenoid valve assembly 62 which produces a pressure of the fluid at the output of the solenoid valve assembly 62 that is greater than the predetermined pressure of the fluid at the output of the solenoid valve assembly 62.

Therefore, in one exemplary embodiment, the vehicle 10 is turned on which activates the pump 24. The controller 64 senses or reads various vehicle operating conditions and determines whether the fluid from the pump 24 should be routed to the primary circuit 40 or to the secondary circuit 50. If the controller 64 determines that it is desirable for the fluid from the output of the pump 24 to be routed to the primary circuit 40, the controller 64 sends a signal of known current to the solenoid valve assembly 62 which produces a pressure of the fluid at the output of the solenoid valve assembly 62 that is below approximately 6 bar. The controller is continuously monitoring the vehicle operating conditions such that when vehicle operating conditions change and the controller 64 determines it is desirable for the fluid from the output of the pump 24 to be routed to the secondary circuit 50, the controller changes the current of the signal to the solenoid valve assembly 62 which produces a pressure at the output of the solenoid valve assembly 62 that is above approximately 6.6 bar. During operation, the switch valve assembly 70 may be switched between directing the fluid from the output of the pump 24 to the primary circuit 40 and to the secondary circuit 50 as often as necessary for optimal vehicle operation.

By controlling the switch valve assembly 70 using the pressure of a fluid in a solenoid which is already located in the vehicle 10 for a different use allows all of the benefits of having a separate independent control solenoid without the added expense or space. More specifically, using the switch valve assembly 70 tied to the solenoid valve assembly 62 in the clutch lubrication circuit 56, as described herein, takes advantage of an excess control pressure range from an already used solenoid and allows more direct control than prior art valves which may use a line pressure. Moreover, the switch valve assembly 70 described herein offers the same performance as a switch valve assembly 70 controlled by a separate dedicated solenoid. Additionally, eliminating the need for an additional control solenoid saves packaging space within the vehicle and reduces overall costs.

Another drawback of using line pressure to control the switch valve assembly 70 is that the range of pressures at which the flow is switched may occur at typical operating ranges, which leads to undesirable flow restriction during operation. However, by using the pressure of the fluid at the output of the solenoid valve assembly 62, as described herein, the range at which the flow is stopped is easily avoided at critical operating conditions which helps prevent undesirable flow restriction and pressure changes.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. A hydraulic system for moving a fluid, said hydraulic circuit comprising:
a controller;
a hydraulic circuit comprising:
an electric pump;
a primary circuit fluidly coupled with said pump;
a secondary circuit fluidly coupled with said pump; and
a hydraulic control module for controlling output of the fluid from said pump, said hydraulic control module comprising:
a solenoid valve assembly, said controller being configured to control a pressure of the fluid at an output of said solenoid valve assembly; and
a switch valve assembly configured to selectively route the fluid from said pump to said primary circuit when the pressure of the fluid at the output of said solenoid valve assembly is lower than a predetermined pressure of the fluid at the output of said solenoid valve assembly and to selectively route the fluid from said pump to said secondary circuit when the pressure of the fluid at the output of said solenoid valve assembly is greater than said predetermined pressure of the fluid at the output of said solenoid valve assembly.

2. The hydraulic system according to claim 1, wherein said controller commands the pressure of the fluid at the output of the solenoid valve assembly

3. The hydraulic system according to claim 1, wherein said solenoid valve assembly is a variable bleed solenoid. Add dependent 2 as claim 16

4. The hydraulic system according to claim 1, wherein said solenoid valve assembly is a spool valve type pressure regulation solenoid.

5. The hydraulic system according to claim 3, wherein said primary circuit fluidly couples a pressure regulator and said pump.

6. The hydraulic system according to claim 3, further including a mechanical pump such that the hydraulic circuit is a dual pump system.

7. The hydraulic system according to claim 3, wherein said controller is also configured to control fluid flow to a lube regulator valve based on the pressure of the fluid at the output of the solenoid valve assembly.

8. The hydraulic system according to claim 7, wherein a range of pressures of fluid at the output of the solenoid valve assembly used by the controller to control output of the fluid from said pump is a first range of pressures and a range of pressures of fluid at the output of the solenoid valve assembly used by the controller to control output of the fluid from the lube regulator valve is a second range of pressures.

9. The hydraulic system according to claim 8, wherein said first range of pressures and said second range of pressures do not overlap.

10. The hydraulic system according to claim 3, wherein said secondary circuit is a cooling circuit for fluidly coupling a cooler and said pump.

11. The hydraulic system according to claim 3, further comprising a clutch lubrication circuit for providing lubrication to at least one clutch assembly, said solenoid valve assembly being coupled with said at least one clutch assembly.

12. A method for controlling fluid flow within a hydraulic system, the hydraulic system comprising a controller and a hydraulic circuit, the hydraulic circuit comprising a pump; a primary circuit fluidly coupled with the pump; a secondary circuit fluidly coupled with the pump; and a hydraulic control module for controlling output of the fluid from the pump, the hydraulic control module having a solenoid valve assembly and a switch valve assembly, the method comprising:
routing the fluid from the pump to the primary circuit when the pressure of the fluid at the output of the solenoid valve assembly is lower than a predetermined pressure of the fluid at the output of the solenoid valve assembly; and
routing the fluid from the pump to the secondary circuit when the pressure of the fluid at the output of the solenoid valve assembly is greater than the predetermined pressure of the fluid at the output of the solenoid valve assembly.

13. The method according to claim 12, further comprising the step of controlling the pressure of the fluid at the output of the solenoid valve assembly using the controller.

14. The method according to claim 12, further comprising the step of commanding the pressure of the fluid at the output of the solenoid valve assembly using the controller.

15. The method according to claim 14, wherein the controller commands the pressure of the fluid at the output of the solenoid valve assembly based on a plurality of operating conditions of the hydraulic circuit.

16. The method according to claim 13, further comprising the step of commanding the pressure of the fluid at the output of the solenoid valve assembly using the controller.

17. The hydraulic system according to claim 2, wherein said solenoid valve assembly is a variable bleed solenoid.

18. The hydraulic system according to claim 2, wherein said solenoid valve assembly is a spool valve type pressure regulation solenoid.
